(19) United States
(12) Patent Application Publication
(10) Pub. No.: US 2004/0146805 A1
(43) Pub. Date: Jul. 29, 2004

(54) Optical recording medium

(75) Inventors: Tatsuya Kato, Tokyo (JP); Hiroshi Shingai, Tokyo (JP); Tatsuhiro Kobayashi, Tokyo (JP); Hideki Hirata, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/756,036

(22) Filed: Jan. 13, 2004

(30) Foreign Application Priority Data
Jan. 15, 2003 (JP) 2003-006949

(51) Int. Cl. G11B 7/24

(52) U.S. Cl. 430/270.13; 369/275.4; 369/288; 430/945; 428/64.5

(57) ABSTRACT

An optical recording medium includes a recording layer in which a record mark can be formed by projecting a laser beam thereonto, a first dielectric layer disposed on the side of a light incidence plane with respect to the recording layer, a second dielectric layer disposed on the opposite side to the light incidence plane with respect to the recording layer, a heat radiation layer disposed on the side of the light incidence plane with respect to the first dielectric layer and a reflective layer disposed on the opposite side to the light incidence plane with respect to the second dielectric layer, the recording layer containing a phase change material represented by a general formula: (SbₓTe₊ₓ)_{+y} M_{y} wherein M is an element other than Sb and Te, the first dielectric layer containing a mixture of ZnS and SiO₂, the reflective layer containing Ag or alloy containing 90 atomic % or more of Ag, and the heat radiation layer containing 90 atomic % or more of aluminum nitride. According to the present invention, it is possible to provide a data rewritable type optical recording medium whose durability is improved when data are reproduced repeatedly, which can suppress cross-erasing of data when data are to be recorded or erased and in which data can be recorded with high sensitivity at a high velocity.

### BACKGROUND OF THE INVENTION

The present invention relates to an optical recording medium and, particularly, to a data rewritable type optical recording medium whose durability when data were reproduced repeatedly is improved when data are reproduced, which can suppress cross-erasing of data when data are to be recorded or erased and in which data can be recorded with high sensitivity at a high velocity.

### DESCRIPTION OF THE PRIOR ART

Optical recording media such as the CD, DVD and the like have been widely used as recording media for recording digital data. These optical recording media can be roughly classified into optical recording media such as the CD-ROM and the DVD-ROM that do not enable writing and rewriting of data (ROM type optical recording media), optical recording media such as the CD-R and DVD-R that enable writing but not rewriting of data (write-once type optical recording media), and optical recording media such as the CD-RW and DVD-RW that enable rewriting of data (data rewritable type optical recording media).

As well known in the art, data are generally recorded in a ROM type optical recording medium using prepits formed in a substrate in the manufacturing process thereof, while in a write-once type optical recording medium, an organic dye such as a cyanine dye, phthalocyanine dye or azo dye is generally used as the material of the recording layer and data are recorded utilizing changes in an optical characteristic caused by chemical change of the organic dye, which change may be accompanied by physical deformation.

On the other hand, in a data rewritable type optical recording medium, a phase change material is generally used as the material of the recording layer and data are recorded utilizing changes in an optical characteristic caused by phase change of the phase change material. More specifically, since the reflection coefficients of the phase change material are different between the case where the phase change material is in a crystal phase and the case where it is in an amorphous phase, data can be recorded and reproduced utilizing these characteristics of the phase change material.

In the case where data are to be recorded in a recording layer of a data rewritable type optical recording medium, a laser beam whose power is set to a recording power Pw having a sufficiently high level is projected onto the recording layer to heat a region of the recording layer irradiated with the laser beam to a temperature equal to or higher than the melting point of a phase change material, thereby melting the region of the recording layer. Then, a laser beam whose power is set to a bottom power Pb having a sufficiently low level is projected onto the recording layer to quickly cool the melted region of the recording layer. As a result, the phase of the phase change material contained in the region of the recording layer changes from a crystal phase to an amorphous phase to form a record mark, thereby recording data therein.

On the other hand, in the case where a record mark formed in the recording layer of a data rewritable type optical recording medium is to be erased, a laser beam whose power set to the erasing power Pe having a level lower than the recording power Pw and equal to or higher than the bottom power Pb is projected onto the recording layer to heat a region of the recording layer where a record mark is formed to a temperature equal to or higher than the crystallization temperature of the phase change material and the region of the recording layer heated to the temperature equal to or higher than the crystallization temperature of the phase change material is gradually cooled. Thus, the phase of the phase change material contained at the region of the recording layer where the record mark was formed changes from an amorphous phase to a crystalline phase and the record mark is erased.

Therefore, it is possible not only to form a record mark in the recording layer but also to directly overwrite a record mark formed in the region of the recording layer by modulating the power of the laser beam projected onto the recording layer between a plurality of levels corresponding to the recording power Pw, the bottom power Pb and the erasing power Pe.

On the other hand, a next-generation type optical recording medium that offers improved recording density and has an extremely high data transfer rate has been recently proposed.

In such a next-generation type optical recording medium, the achievement of increased recording capacity and extremely high data transfer rate inevitably requires the diameter of the laser beam spot used to record and reproduce data to be reduced to a very small size.

In order to reduce the laser beam spot diameter, it is necessary to increase the numerical aperture of the objective lens for condensing the laser beam to 0.7 or more, for example, to about 0.85, and to shorten the wavelength of the laser beam to 450 nm or less, for example, to about 400 nm.

However, if the numerical aperture of the objective lens for condensing the laser beam is increased, then, as shown by Equation (1), the permitted tilt error of the optical axis of the laser beam to the optical recording medium, namely, the tilt margin T, has to be greatly decreased.

$$T ∝ \frac{λ}{d \cdot {NA}^{3}} \qquad ( 1 )$$

In Equation (1), λ is the wavelength of the laser beam used for recording and reproducing data and d is the thickness of the light transmission layer through which the laser beam transmits.

As apparent from Equation (1), the tilt margin T decreases as the numerical aperture of the objective lens increases and increases as the thickness of the light transmission layer decreases. Therefore, decrease of the tilt margin T can be effectively prevented by making the thickness of the light transmission layer thinner.

On the other hand, a wave aberration coefficient W representing coma is defined by Equation (2).

$$W = \frac{d \cdot ( {n}^{2} - 1 ) \cdot {n}^{2} \cdot sin θ \cdot cos θ \cdot {( NA )}^{3}}{2 {λ ( {n}^{2} - {sin}^{2} θ )}^{\frac{5}{2}}} . \qquad ( 2 )$$

In Equation (2), n is the refractive index of the light transmission layer and θ is the tilt of the optical axis of the laser beam.

As apparent from Equation (2), coma can also be very effectively suppressed by making the thickness of the light transmission layer thinner.

For these reasons, it has been proposed that the thickness of the light transmission layer of the next-generation type optical recording medium should be reduced as far as about 100 μm in order to ensure sufficient tilt margin and suppress coma.

As a result, it becomes difficult to form a layer such as a recording layer on the light transmission layer as is done in conventional optical recording media such as the CD and DVD. This led to the proposal that the light transmission layer be constituted as a thin resin layer formed by spin coating or the like on a recording layer or other such layer formed on a substrate.

Accordingly, although layers are sequentially formed from the side of the light incidence surface in a conventional optical recording medium, they are sequentially formed from the side opposite from the light incidence surface in a next-generation optical recording medium.

Thus, an extremely high data transfer rate is required for a next-generation type optical recording medium and in order to achieve an extremely high data transfer rate in an optical recording medium having a recording layer formed of a phase change material, it is necessary to form a recording layer of a phase change material having a high crystallization velocity.

However, in the case where a recording layer is formed of a phase change material having a high crystallization velocity, since a phase change material in an amorphous phase crystallizes in an extremely short time when a record mark is to be erased, the durability of the optical recording medium when data are reproduced repeatedly declines and when data are recorded in or data are erased from a particular track, data recorded in neighboring tracks are erased, whereby cross-erasing of data is apt to occur.

Since these problems become pronounced as the power of the laser beam per unit area increases, they become particularly serious in a next-generation type optical recording medium.

These problems can be solved by adjusting the composition(s) and the thickness(es) of a dielectric layer (s) adjacent with the recording layer to improve the heat radiation characteristics of the recording layer but if the heat radiation characteristics are too high, the recording sensitivity of an optical recording medium decreases.

### SUMMARY OF THE INVENTION

It is therefore an object of the present invention to provide a data rewritable type optical recording medium whose durability is improved when data are reproduced repeatedly, which can suppress cross-erasing of data when data are to be recorded or erased and in which data can be recorded with high sensitivity at a high velocity.

The above and other objects of the present invention can be accomplished by an optical recording medium comprising a recording layer in which a record mark can be formed by projecting a laser beam thereonto, a first dielectric layer disposed on the side of a light incidence plane through which the laser beam enters with respect to the recording layer, a second dielectric layer disposed on the opposite side to the light incidence plane with respect to the recording layer, a heat radiation layer disposed on the side of the light incidence plane with respect to the first dielectric layer and a reflective layer disposed on the opposite side to the light incidence plane with respect to the second dielectric layer, the recording layer containing a phase change material represented by a general formula: (SbₓTe₁₋ₓ)_{1-y}M_{y} wherein M is an element other than Sb and Te, the first dielectric layer containing a mixture of ZnS and SiO₂, the reflective layer containing Ag or alloy containing 90 atomic % or more of Ag, and the heat radiation layer containing 90 atomic % or more of aluminum nitride.

Since a phase change material represented by a general formula: (SbₓTe₁₋ₓ)_{1-y}M_{y} wherein M is an element other than Sb and Te changes from an amorphous phase to a crystal phase in a short time and has a high crystallization velocity, the present invention enables data to be recorded in the recording layer at a high velocity.

Further, according to the present invention, since the reflective layer disposed on the opposite side to the light incidence plane with respect to the second dielectric layer contains Ag or alloy containing 90 atomic % or more of Ag and the heat radiation layer disposed on the side of the light incidence plane with respect to the first dielectric layer contains 90 atomic % or more of aluminum nitride, the heat radiation characteristics of the recording layer can be increased and it is therefore possible to improve the durability of the optical recording medium when data are reproduced repeatedly and to suppress cross-erasing of data when data are to be recorded or erased.

Furthermore, according to the present invention, since the heat radiation layer is disposed on the side of the light incidence plane with respect to the recording layer, it is possible to prevent the heat radiation characteristics of the recording layer from increasing too much and it is therefore possible to effectively prevent the recording sensitivity of the optical recording medium from being lowered.

Moreover, according to the present invention, since the first dielectric layer contains the mixture of ZnS and SiO₂ having excellent adhesiveness with the recording layer and an excellent optical property, it is possible to improve overwriting characteristics and to reduce jitter.

In the present invention, the mole ratio of the mixture of ZnS and SiO₂ contained is preferably 70:30 to 90:10 and most preferably about 80:20. Since the mixture of ZnS and SiO₂ whose mole ratio is 70:30 to 90:10 has an excellent optical property, it is possible to further improve overwriting characteristics and to further reduce jitter.

In the present invention, although M in the general formula of the phase change material is not particularly limited, it is preferable for the element M to be one or more elements selected from the group consisting of In, Ag, Au, Bi, Se, Al, P, Ge, H, Si, C, V, W, Ta, Zn, Mn, Ti, Sn, Pd, Pb, N, O and rare earth elements in order to shorten time required for crystallization and improve the storage reliability of the optical recording medium. It is particularly preferable for M to be one or more elements selected from the group consisting of Ag, In, Ge and rare earth elements for improving the storage reliability of the optical recording medium.

In the present invention, it is more preferable to use one or more elements selected from the group consisting of In, Ag, Ge and rare earth elements as M and it is most preferable to employ Ge and Tb or Ge and Mn as M. In the case where Ge and Tb or Ge and Mn are employed as M, since the crystallization velocity of the phase change material can be further increased and the crystallization temperature of the phase change material can be increased, it is possible to much more improve overwriting characteristics and to much more reduce jitter. As a result, the track pitch can be set narrower and data can be therefore recorded in the optical recording medium at a higher density.

In the present invention, it is preferable that x in the general formula of the phase change material be equal to or larger than 0.55 and equal to or smaller than 0.9 and that y in the general formula of the phase change material be equal to or larger than 0 and equal to or smaller than 0.25 and it is more preferable that x be equal to or larger than 0.65 and equal to or smaller than 0.85 and y be equal to or larger than 0 and equal to or smaller than 0.25.

In the present invention, the second dielectric layer preferably contains a mixture of ZnS and SiO2 whose mole ratio is 40:60 to 60:40. Since the mixture of ZnS and SiO2 whose mole ratio is 40:60 to 60:40 has excellent characteristics for protecting the recording layer and relatively low thermal conductivity, it is possible to improve the recording sensitivity of the optical recording medium.

In a preferred aspect of the present invention, a track pitch TP is determined so that TP/(λ/NA) is smaller than 0.7 where λ is a wavelength of the laser beam and NA is a numerical aperture of an objective lens. In the optical recording medium according to the present invention, since cross-erasing of data when data are recorded or erased can be effectively suppressed, it is possible to determine the track pitch in this manner and record data in the optical recording medium.

In a further preferred embodiment of the present invention, the optical recording medium further comprises a light transmission layer disposed on the side of the light incidence plane with respect to the heat radiation layer and is constituted so that data are recorded therein by employing an objective lens and a laser beam whose numerical aperture NA and wavelength λ satisfy λ/NA≦640 nm, and projecting the laser beam onto the recording layer via the light transmission layer.

The above and other objects and features of the present invention will become apparent from the following description made with reference to the accompanying drawings.

### BRIEF DESCRIPTION OF THE DRAWINGS

FIG. 1 is a schematic perspective view showing an optical recording medium that is a preferred embodiment of the present invention.

FIG. 2 is an enlarged schematic cross-sectional view of the part of the optical recording medium indicated by A in FIG. 1.

FIG. 3 is a graph showing how cross-erasing of data CE varied with TP/(λ/NA) in Working Example 3.

FIG. 4 is a graph showing how clock jitter varied with the recording power of a laser beam in Working Example 4.

FIG. 5 is a graph showing how clock jitter varied with the recording power of a laser beam in Working Example 4.

### DESCRIPTION OF THE PREFERRED EMBODIMENTS

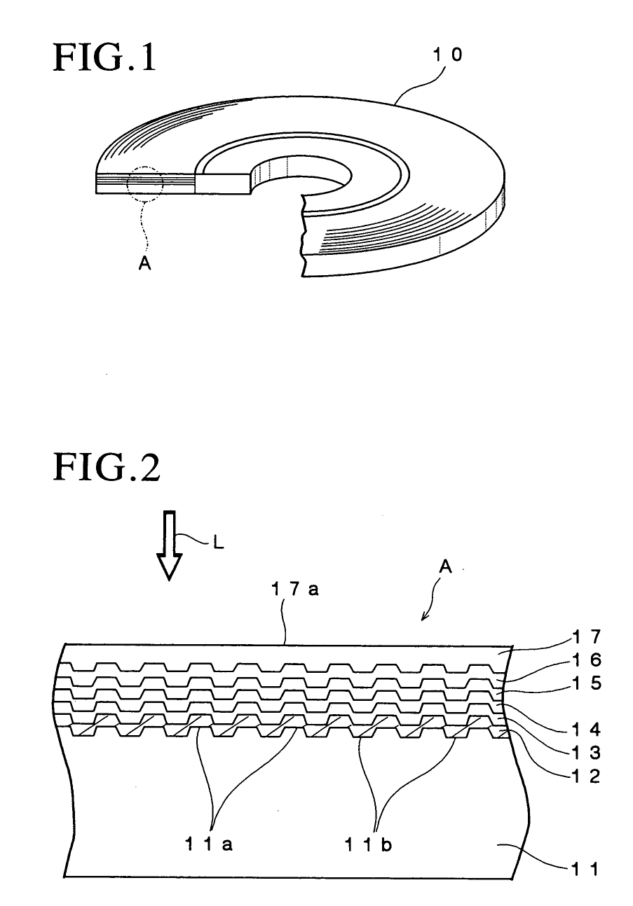

FIG. 1 is a schematic perspective view showing an optical recording medium that is a preferred embodiment of the present invention and FIG. 2 is a schematic enlarged cross-sectional view indicated by A in FIG. 1.

As shown in FIG. 1, an optical recording medium 10 according to this embodiment is formed disk-like and has a outer diameter of about 120 mm and a thickness of about 1.2 mm.

As shown in FIG. 2, the optical recording medium 10 according to this embodiment includes a disk-like support substrate 11, a reflective layer 12, a second dielectric layer 13, a recording layer 14, a first dielectric layer 15, a heat radiation layer 16 and a light transmission layer 17.

The optical recording medium 10 according to this embodiment is constituted so that a laser beam L having a wavelength λ of 380 nm to 450 nm is projected onto the recording layer 14 via the light transmission layer 17 and a light incidence plane 17a is formed by the surface of the light transmission layer 17.

The support substrate 11 serves as a support for ensuring mechanical strength and a thickness of about 1.2 mm required for the optical recording medium 10.

The material used to form the support substrate 11 is not particularly limited insofar as the support substrate 11 can serve as the support of the optical recording medium 10. The support substrate 11 can be formed of glass, ceramic, resin or the like. Among these, resin is preferably used for forming the support substrate 11 since resin can be easily shaped. Illustrative examples of resins suitable for forming the support substrate 11 include polycarbonate resin, polyolefin resin, acrylic resin, epoxy resin, polystyrene resin, polyethylene resin, polypropylene resin, silicone resin, fluoropolymers, acrylonitrile butadiene styrene resin, urethane resin and the like. Among these, polycarbonate resin and polyolefin resin are most preferably used for forming the support substrate 11 from the viewpoint of easy processing, optical characteristics and the like and in this embodiment, the support substrate 11 is formed of polycarbonate resin. In this embodiment, since the laser beam L is projected onto the recording layer 14 via the light transmission layer 17 located opposite to the support substrate 11, it is unnecessary for the support substrate 11 to have a light transmittance property.

In this embodiment, the support substrate 11 has a thickness of about 1.1 mm.

As shown in FIG. 2, grooves 11a and lands 11b are alternately and spirally formed on the surface of the support substrate 11. The grooves 11a and/or lands 11b serve as a guide track for the laser beam L when data are to be recorded in the optical recording medium 10 or when data are to be reproduced from the optical recording medium 10.

The depth of the groove 11a is not particularly limited and is preferably set to 10 nm to 40 nm. The pitch of the grooves 11a is not particularly limited and is preferably set to 0.2 μm to 0.4 μm.

It is preferable to fabricate the support substrate 11 by an injection molding process using a stamper but the support substrate 11 may be fabricated using another process such as a 2P process.

The reflective layer 12 serves to reflect the laser beam L entering through the light incidence plane 17a so as to emit it from the light incidence plane 17a and effectively radiate heat generated in the recording layer 14 by the irradiation with the laser beam L. Further, the reflective layer 12 serves to increase a reproduced signal (C/N ratio) by a multiple interference effect.

In this embodiment, the reflective layer 12 is formed of Ag or alloy containing 90 atomic % or more of Ag, thereby improving the reflection coefficient thereof and a property thereof for radiating heat generated in the recording layer 14.

It is preferable to form the reflective layer 12 to have a thickness of 5 to 300 nm and is more preferable to form it to have a thickness of 20 to 200 nm.

In the case where the thickness of the reflective layer 12 is thinner than 5 nm, the above described effects cannot sufficiently be obtained. On the other hand, in the case where the thickness of the reflective layer 12 exceeds 300 nm, the surface smoothness of the reflective layer 12 is degraded and it takes a longer time for forming the reflective layer 12, thereby lowering the productivity of the optical recording medium 10.

The recording layer 14 is a layer in which record marks are to be formed, whereby data are recorded. The recording layer 14 is formed of a phase change material. The reflection coefficients of the phase change material are different between the case where the phase change material is in a crystal phase and the case where it is in an amorphous phase, and data are recorded utilizing this characteristic of the phase change material.

When the laser beam L is projected onto the recording layer 14, whereby the phase of a region of the recording layer 14 is changed from a crystal phase to an amorphous phase to form a record mark, the laser beam L set to the recording power Pw is projected onto the recording layer 14 via the light transmission layer 17 to heat the region of the recording layer 14 irradiated with the laser beam L to a temperature equal to or higher than the melting point of the phase change material, thereby melting it and the laser beam L set to the bottom power Pb lower than the recording power Pw is then projected onto the recording layer 14, thereby quickly cooling the melted region of the recording layer 14 to change the phase thereof to an amorphous phase. Thus, a record mark is formed at the region of the recording layer 14 whose phase is in an amorphous phase.

Data are constituted by the length of the record mark and the length of the blank region between the record mark and the neighboring record mark in the direction of the track.

Each of the length of the record mark and that of the blank region is determined to be an integral multiple of T, where T is a length corresponding to one cycle of a reference clock and in the 1,7RLL Modulation Code, a record mark and a blank region having a length of 2T to 8T are used.

On the other hand, when the region of the recording layer 14 in an amorphous phase is crystallized, thereby erasing the record mark, the laser beam L set to the erasing power Pe equal to or higher than the bottom power Pb is projected onto the recording layer 14 via the light transmission layer 17 to heat the region of the recording layer 14 to a temperature equal to or higher than the crystallization temperature of the phase change material and the region of the recording layer 14 is gradually cooled by moving the laser beam L away therefrom. Thus, the region of the recording layer 14 is crystallized and the record mark is erased.

Therefore, it is possible by modulating the power of the laser beam L projected onto the recording layer 14 to form a record mark in the recording layer 14 and directly overwrite a record mark formed in the region of the recording layer 14.

In this embodiment, the recording layer 14 is formed of a phase change material represented by a general formula: (SbₓTe₊ₓ)_{1-y}M_{y} where M is an element other than Sb and Te, x is equal to or larger than 0.55 and equal to or smaller than 0.9 and y is equal to or larger than 0 and equal to or smaller than 0.25. Preferably, x is equal to or larger than 0.65 and equal to or smaller than 0.85 and y is equal to or larger than 0 and equal to or smaller than 0.25.

Since the phase change material represented by the above a general formula changes from an amorphous phase to a crystal phase in a short time, in other words, time required for crystallizing the phase change material, data can be overwritten in the recording layer 14 at a high velocity.

While M is not particularly limited, it is preferable for the element M to be one or more elements selected from the group consisting of In, Ag, Au, Bi, Se, Al, P, Ge, H, Si, C, V, W, Ta, Zn, Mn, Ti, Sn, Pd, Pb, N, O and rare earth elements in order to shorten time required for crystallization and improve the storage reliability of the optical recording medium 10.

It is particularly preferable for the element M to be one or more elements selected from the group consisting of Ag, In, Ge and rare earth elements for improving the storage reliability of the optical recording medium 10.

In order to improve the storage reliability of the optical recording medium 10, it is more preferable to use one or more elements selected from the group consisting of In, Ag, Ge and rare earth elements as the element M and it is most preferable to use Ge and Tb or Ge and Mn as the element M.

By using these elements as the element M, it is possible to further increase the crystallization velocity of the recording layer 14 and the crystallization temperature thereof and it is therefore possible to further improve the durability of the optical recording medium 10 when data are reproduced repeatedly and suppress the cross-erasing of data when data are recorded or erased.

Since the recording sensitivity decreases as the recording layer becomes thicker, it is preferable to form the recording layer to be thin. However, when the recording layer 14 is too thin, the difference in the optical constants between before and after data recording becomes small and a reproduced signal having a high level (C/N ratio) cannot be obtained. When the recording layer 14 is too thin, it is difficult to control the thickness of the recording layer 14 when it is formed. Therefore, the recording layer 14 is preferably formed to have a thickness of 2 to 40 nm, more preferably, to have a thickness of 2 to 20 nm and most preferably to have a thickness of 2 to 15 nm.

The heat radiation layer 16, the first dielectric layer 15 and the second dielectric layer 13 serve to physically and chemically protect the recording layer 14 and to increase the difference in the optical characteristics between before and after data recording. It is possible to effectively prevent data recorded in the recording layer 14 from being degraded for a long time by sandwiching the recording layer 14 by the first dielectric layer 15 and the second dielectric layer 13. In addition, the heat radiation layer 16 serves to quickly radiate heat generated in the recording layer 14.

The thickness of the heat radiation layer 16 is not particularly limited but it is preferable to form the heat radiation layer 16 to have a thickness of 50 nm to 150 nm and is more preferable to form the heat radiation layer 16 to have a thickness of 80 nm to 120 nm. In the case where the thickness of the heat radiation layer 16 is thinner than 50 nm, sufficient heat radiation characteristics cannot be obtained and, on the other hand, in the case where the thickness of the heat radiation layer 16 exceeds 150 nm, it takes much time to form the heat radiation layer 16, thereby lowering the productivity of the optical recording medium 10 and giving rise to a risk of cracks being generated in the heat radiation layer 16 due to internal stress.

In this embodiment, the first dielectric layer 15 located on the side of the light incidence plane 17a with respect to the recording layer 14 is formed of a mixture of ZnS and SiO₂. The mole ratio of ZnS to SiO₂ is preferably 70:30 to 90:10 and most preferably about 80:20. It is possible by forming the first dielectric layer 15 in this manner to improve the characteristics for protecting the recording layer 14 and effectively prevent the recording layer 14 from being deformed by heat generated when data are recorded therein. The thus formed first dielectric layer 15 has an excellent optical characteristic with respect to the laser beam L having a wavelength included in a blue wavelength region.

The thickness of the first dielectric layer 15 is not particularly limited but the first dielectric layer 15 is preferably formed to have a thickness of 10 nm to 60 nm and more preferably formed to have a thickness of 10 nm to 40 nm. In the case where the thickness of the first dielectric layer 15 is thinner than 10 nm, it becomes difficult to protect the recording layer 14 in a desired manner and on the other hand, in the case where the thickness of the first dielectric layer 15 exceeds 60 nm, the heat radiation effect of the heat radiation layer 16 becomes low.

In the case where the first dielectric layer 15 and the heat radiation layer 16 are integrated and formed of the material containing 90 atomic % or more of aluminum nitride, it is possible to much more effectively radiate heat generated in the recording layer 14. However, in the case where a layer integrated by the first dielectric layer 15 and the heat radiation layer 16 is formed of the material containing 90 atomic % or more of aluminum nitride, since the adhesiveness between itself and the recording layer 14 is low, the data overwriting characteristics are lowered if the layer is brought into direct contact with the recording layer 14, and since aluminum nitride has little enhancement effect, sufficient modulation cannot be obtained, whereby the jitter characteristics are lowered. Therefore, in this embodiment, the first dielectric layer 15 and the heat radiation layer 16 are separately provided.

The material usable for forming the second dielectric layer 13 is not particularly limited insofar as it is transparent with respect to the laser beam L and it is preferable to form the second dielectric layer 13 of a mixture of ZnS and SiO₂. The mole ratio of ZnS to SiO₂ is preferably 40:60 to 60:40 and most preferably about 50:50. The mixture of ZnS and SiO₂ whose mole ratio of ZnS to SiO₂ is about 50:50 has an excellent property for protecting the recording layer 14 when the second dielectric layer 13 is formed thereof and relatively low thermal conductivity. Therefore, it is possible to improve the recording sensitivity of the optical recording medium 10 by forming the second dielectric layer 13 of the mixture of ZnS and SiO₂ whose mole ratio of ZnS to SiO₂ is about 50:50.

Since the reflective layer 12 having extremely high thermal conductivity is provided adjacent to the second dielectric layer 13, in the case where the second dielectric layer 13 is formed of a material such as aluminum nitride having extremely high thermal conductivity, the recording sensitivity of the optical recording medium 10 becomes considerably low. Therefore, in this embodiment, the second dielectric layer 13 is formed of the mixture of ZnS and SiO₂ having relatively low thermal conductivity.

The thickness of the second dielectric layer 13 is not particularly limited but the second dielectric layer 13 is preferably formed to have a thickness of 8 nm to 20 nm and more preferably formed to have a thickness of 10 nm to 15 nm. In the case where the thickness of the second dielectric layer 13 is thinner than 8 nm, it becomes difficult to protect the recording layer 14 in a desired manner and, on the other hand, in the case where the thickness of the second dielectric layer 13 exceeds 20 nm, there is a risk of cracks being generated in the second dielectric layer 13 due to internal stress and the heat radiation effect thereof becomes low.

Each of the reflective layer 12, the second dielectric layer 13, the recording layer 14, the first dielectric layer 15 and the heat radiation layer 16 can be formed using a gas phase growth process using chemical species containing elements for forming it. As the gas phase growth process, a sputtering process is preferably used.

The light transmission layer 17 serves to transmit the laser beam L and the light incidence plane 17a is constituted by the surface thereof. It is preferable to form the light transmission layer 17 to have a thickness of 10 μm to 300 μm and is more preferable to form the light transmission layer 17 to have a thickness of 50 μm to 150 μm.

The material usable for forming the light transmission layer 17 is not particularly limited insofar as it has a sufficiently high light transmittance with respect to the laser beam L but it is preferable to form the light transmission layer 17 by applying acrylic ultraviolet ray curable resin or epoxy ultraviolet ray curable resin onto the surface of the heat radiation layer 16 using a spin coating process.

The light transmission layer 17 may be formed by adhering a sheet made of light transmittable resin to the surface of the heat radiation layer 16 using an adhesive agent.

When data are to be recorded in the thus constituted optical recording medium 10, a laser beam L whose power is set to the recording power Pw is projected onto the recording layer 14 via the light transmission layer 17 to heat a region of the recording layer 14 irradiated with the laser beam L to a temperature equal to or higher than the melting point of the phase change material, thereby melting it.

The laser beam L whose power is set to the bottom power Pb lower than the recording power Pw is then projected onto the recording layer 14, thereby quickly cooling the melted region of the recording layer 14 to change the phase thereof to an amorphous phase.

Thus, a record mark is formed in the recording layer 14 and data are recorded therein.

Since the reflection coefficients of the phase change material are different between the case where the phase change material is in a crystal phase and the case where it is in an amorphous phase, data can be reproduced utilizing these characteristics of the phase change material.

On the other hand, when a record mark formed in the recording layer 14 is to be erased, the laser beam L whose power is set to the erasing power Pe equal to or higher than the bottom power Pb is projected onto a region of the recording layer 14 where the record mark is formed via the light transmission layer 17 to heat the region of the recording layer 14 irradiated with the laser beam L to a temperature equal to or higher than the crystallization temperature of the phase change material

Then, the region of the recording layer 14 is gradually cooled by moving the laser beam L away therefrom.

Thus, the phase change material contained is crystallized and the record mark which was formed at the region of the recording layer 14 is erased.

According to this embodiment, since the recording layer 14 of the optical recording medium 10 is formed of a phase change material which is represented by the general formula: (SbₓTe₊ₓ)_{1-y}M_{y} and can change from an amorphous phase to a crystal phase in a short time, namely, has a high crystallization velocity, data can be recorded at a high velocity.

Further, according to this embodiment, since the reflective layer 12 is formed of Ag or alloy containing 90 atomic % or more of Ag and the heat radiation layer 16 is formed of a material containing 90 atomic % or more of aluminum nitride between the first dielectric layer 15 and the light transmission layer 17, heat generated in the recording layer 14 can be quickly radiated. Therefore, cross-erasing of data can be suppressed even when data are recorded at a low linear recording velocity and the durability of the optical recording medium 10 when data were reproduced repeatedly can be improved even when data are reproduced at a low linear velocity. Accordingly, since the track pitch can be set narrower, data can be recorded at high density As a result, the optical recording medium according to this embodiment is suitable when multi-speed recording is performed and when data are recorded using the CAV (constant angular velocity) format.

### WORKING EXAMPLES

Hereinafter, working examples will be set out in order to further clarify the advantages of the present invention.

### Working Example 1

An optical recording medium sample # 1 was fabricated in the following manner.

A substrate of polycarbonate having a thickness of 1.1 mm and a diameter of 120 mm and formed with grooves and lands on the surface thereof was first fabricated by an injection molding process so that the track pitch (groove pitch) was equal to 0.32 μm. The depth of the groove was 25 nm.

Then, the substrate was set on a sputtering apparatus and a reflective layer consisting of an alloy of Ag, Pd and Cu and having a thickness of 100 nm, a second dielectric layer consisting of a mixture of ZnS and SiO₂ and having a thickness of 12 nm, a recording layer consisting of Ge_{0.06}Sb_{0.76}Te_{0.18} and having a thickness of 12 nm, a first dielectric layer consisting of the mixture of ZnS and SiO₂ and having a thickness of 30 nm and a heat radiation layer containing 90 atomic % of more of aluminum nitride and having a thickness of 100 nm were sequentially formed on the surface of the substrate on which the grooves and lands were formed, using the sputtering process.

The mole ratio of ZnS to SiO₂ in the mixture of ZnS and SiO₂ contained in the first dielectric layer and the second dielectric layer was 80:20.

Further, the support substrate formed with the reflective layer, the second dielectric layer, the recording layer, the first recording layer and the heat radiation layer on the surface there of was set on a spin coating apparatus and the heat radiation layer was coated with a resin solution prepared by dissolving acrylic ultraviolet curing resin in a solvent to form a coating layer and the coating layer was irradiated with ultraviolet rays, thereby curing the acrylic ultraviolet curing resin to form a protective layer having a thickness of 100 μm.

Thus, the optical recording medium sample # 1 was fabricated.

Further, an optical recording medium sample #2 was fabricated in the manner of the optical recording medium sample # 1 except that a recording layer consisting of Ge_{0.05}Tb_{0.02}Sb_{0.77}Te_{0.16} was formed.

Then, an optical recording medium comparative sample #1 was fabricated in the manner of the optical recording medium sample # 1 except that a heat radiation layer consisting of Al₂O₃ was formed.

Further, an optical recording medium comparative sample #2 was fabricated in the manner of the optical recording medium sample # 1 except that a second dielectric layer consisting of aluminum nitride was formed.

Each of the optical recording medium sample #1, the optical recording medium sample #2, the optical recording medium comparative sample #1 and the optical recording medium comparative sample #2 was set in an optical recording medium evaluation apparatus “DDU1000” (Product Name) manufactured by Pulstec Industrial Co., Ltd. and a laser beam having a wavelength λ of 405 nm was focused onto each of the recording layers using an objective lens whose numerical aperture was 0.85 via the light transmission layer while each sample was rotated at a linear velocity of 10.5 m/sec, thereby recording random signals including 2T signals to 8T signals in the 1,7 RLL Modulation Code therein. TP/(λ/NA) was about 0.67.

Further, the random signals were recorded in the recording layer of each sample by varying the recording power of the laser beam. The bottom power of the laser beam was fixed at 0.5 mW.

Each of the optical recording medium sample #1, the optical recording medium sample #2, the optical recording medium comparative sample #1 and the optical recording medium comparative sample #2 was set in the above mentioned optical recording medium evaluation apparatus and a laser beam having a wavelength λ of 405 nm was focused onto each of the recording layers using an objective lens whose numerical aperture was 0.85 via the light transmission layer while each sample was rotated at a linear velocity of 10.5 m/sec, thereby reproducing a signal recorded in the recording layer and clock jitter of the reproduced was measured.

The fluctuation σ of a reproduced signal was measured using a time interval analyzer and the clock jitter was calculated as σ/Tw, where Tw was one clock period.

Further, the recording power at which the clock jitter of a reproduced signal was lowest was measured for each of the optical recording medium sample #1, the optical recording medium sample #2, the optical recording medium comparative sample #1 and the optical recording medium comparative sample #2.

The results of the measurement are shown in Table 1.

TABLE 1

| | | | Comparative | Comparative |
|---|---|---|---|---|
| | Sample #1 | Sample #2 | Sample #1 | Sample #2 |
| Recording Power | 6.0 mW | 6.0 mW | 6.2 mW | 7.5 mW |

As shown in Table 1, it was found that the recording power of the laser beam at which the clock jitter of a reproduced signal was lowest was higher in the optical recording medium comparative sample #2 than those in the optical recording medium sample #1 and the optical recording medium sample #2 and that the recording sensitivity of the optical recording medium comparative sample #2 was low.

It is reasonable to conclude that this was because the second dielectric layer of the optical recording medium comparative sample #2 was formed of aluminum nitride having a high thermal conductivity and the heat radiation characteristic of the recording layer was too high.

### Working Example 2

Each of the optical recording medium sample #1, the optical recording medium sample #2, the optical recording medium comparative sample #1 and the optical recording medium comparative sample #2 was set in the above mentioned optical recording medium evaluation apparatus and a laser beam having a wavelength λ of 405 nm whose power was set to the recording power at which the clock jitter of a reproduced signal was lowest onto the recording layer of each sample to record an 8T signal in a predetermined track of the recording layer and the thus recorded 8T signal was then overwritten nine times.

Then, the 8T signal recorded in the predetermined track of the recording layer of each of the optical recording medium sample #1, the optical recording medium sample #2, the optical recording medium comparative sample #1 and the optical recording medium comparative sample #2 was reproduced and the carrier level C1 of the reproduced signal was measured.

Further, a laser beam having a wavelength λ of 405 nm whose power was set to the recording power at which the clock jitter of a reproduced signal was lowest onto tracks of the recording layer of each sample on the opposite sides of the predetermined track to record 7T signals therein and the 7T signals recorded in the tracks were overwritten 99 times. Then, the 8T signal recorded in the predetermined track was reproduced and a carrier level C2 of the reproduced signal was measured.

Based on the thus measured carrier levels C1 and C2 of the reproduced signals, cross-erasing of data was calculated. The cross-erasing of data was defined by (C2-C1).

The results of the calculation are shown in Table 2.

TABLE 2

| | | | Comparative | Comparative |
|---|---|---|---|---|
| | Sample #1 | Sample #2 | Sample #1 | Sample #2 |
| CE | −0.3 dB | 0.0 dB | −0.8 dB | −0.2 dB |

As shown in Table 2, it was found that the cross-erasing of data was larger in the optical recording medium comparative sample #1 than those in the optical recording medium sample #1 and the optical recording medium sample #2 and that cross-erasing of data was apt to occur in the optical recording medium comparative sample #1.

It is reasonable to conclude that this was because the heat radiation layer of the optical recording medium comparative sample #1 was formed of Al₂O₃ having lower thermal conductivity than that of aluminum nitride and the heat radiation characteristics of the recording layer was insufficient.

Further, as shown in Table 2, it was found that while slight cross-erasing of data occurred in the optical recording medium sample #1, no cross-erasing of data occurred in optical recording medium sample #2.

It is reasonable to conclude that this is because the crystallization temperature of the phase change material used for forming the recording layer of optical recording medium sample #2 was higher than that of the phase change material used for forming the recording layer of optical recording medium sample #1.

### Working Example 3

Optical recording medium samples #1-1 to #1-6 were fabricated in the manner of fabricating the optical recording medium sample #1, optical recording medium samples #2-1 to #2-6 were fabricated in the manner of fabricating the optical recording sample #2 and optical recording medium comparative samples #1-1 to #1-6 were fabricated in the manner of fabricating the optical recording medium comparative sample #1, except that each support substrate was formed to have a different groove pitch (track pitch) in the range of 0.26 μm to 0.36 μm.

Then, each of the optical recording medium samples #1-1 to #1-6, the optical recording medium samples #2-1 to #2-6 and the optical recording medium comparative samples #1-1 to #1-6 was set in the above mentioned optical recording medium evaluation apparatus and similarly to Working Example 2, cross-erasing CE of data was measured in each sample, thereby measuring the relationship between cross-erasing CE of data and TP/(λ/NA) where TP was the track pitch, λ was the wavelength of the laser beam and NA was the numerical aperture of the objective lens. λ was equal to 405 nm, and NA was 0.85.

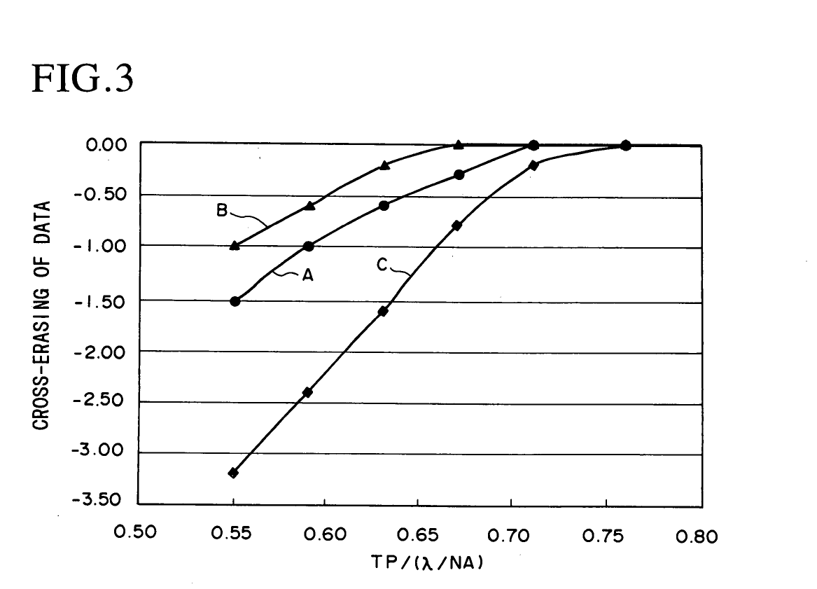

The results of the measurement are shown in FIG. 3.

In FIG. 3, the curve A shows the results of the measurement of the optical recording medium samples #1-1 to #1-6, the curve B shows the results of the measurement of the optical recording medium samples #2-1 to #2-6, and the curve C shows the results of the measurement of the optical recording medium comparative samples #1-1 to #1-6.

As shown in FIG. 3, it was found that in the case where TP/(λ/NA) was equal to or larger than 0.7, the cross-erasing of data was small in each sample but that the cross-erasing of data abruptly increased in the optical recording medium comparative samples #1-1 to #1-6 as TP/(λ/NA) became smaller.

To the contrary, it was found that the cross-erasing of data did not increase so much in the optical recording medium samples #1-1 to #1-6 and the optical recording medium samples #2-1 to #2-6 even if TP/(λ/NA) became smaller and that the increase in the cross-erasing of data was particularly small in the optical recording medium samples #2-1 to #2-6.

### Working Example 4

Each of the optical recording medium sample #2 and the optical recording medium comparative sample #1 was set in the above mentioned optical recording medium evaluation apparatus and similarly to Working Example 1, random signals including 2T signals to 8T signals in the 1,7 RLL Modulation Code were recorded in a predetermined track of the recording layer of each sample.

Further, the random signal was recorded in the predetermined track of the recording layer of each sample using a different recording power of the laser beam. The bottom power of the laser beam was fixed at 0.5 mW.

Then, each of the optical recording medium sample #2 and the optical recording medium comparative sample #1 was set in the above mentioned optical recording medium evaluation apparatus and similarly to Working Example 1, a signal recorded in the predetermined track of the recording layer of each sample was reproduced, whereby clock jitter was measured.

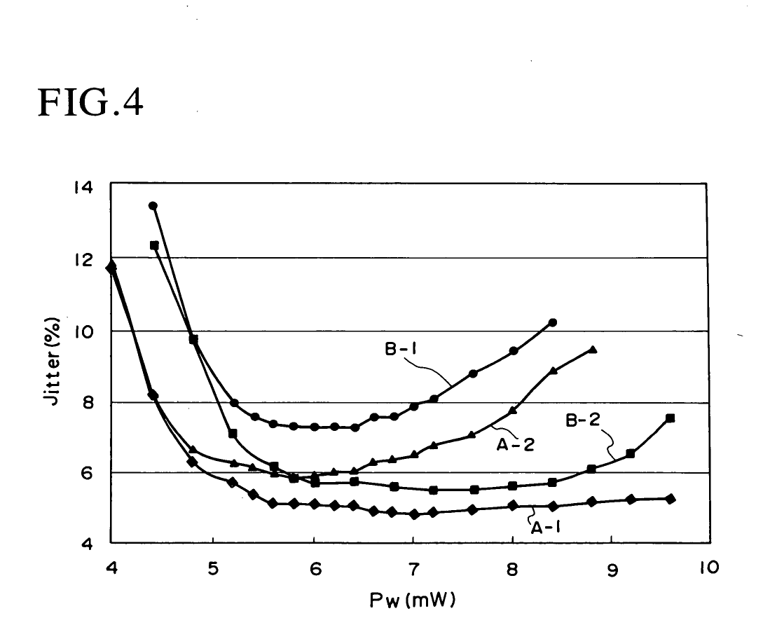

The results of the measurement are shown in FIG. 4.

In FIG. 4, the curve A-1 shows the results of the measurement of the optical recording medium sample #2 and the curve B-1 shows the results of the measurement of the optical recording medium comparative sample #1.

Then, each of the optical recording medium sample #2 and the optical recording medium comparative sample #1 was set in the above mentioned optical recording medium evaluation apparatus and similarly to Working Example 1, random signals were recorded in tracks of the recording layer of each sample on the opposite sides of the predetermined track.

Further, the random signal was recorded in the track of the recording layer of each sample on the opposite side of the predetermined track using a different recording power of the laser beam. The bottom power of the laser beam was fixed at 0.5 mW.

Then, each of the optical recording medium sample #2 and the optical recording medium comparative sample #1 was set in the above mentioned optical recording medium evaluation apparatus and similarly to Working Example 1, a signal recorded in the predetermined track of the recording layer of each sample was reproduced, whereby clock jitter was measured.

The results of the measurement are shown in FIG. 4.

In FIG. 4, the curve A-2 shows the results of the measurement of the optical recording medium sample #2 and the curve B-2 shows the results of the measurement of the optical recording medium comparative sample #1.

Then, each of the optical recording medium sample #2 and the optical recording medium comparative sample #1 was set in the above mentioned optical recording medium evaluation apparatus and random signals including 2T signals to 8T signals in the 1,7 RLL Modulation Code were recorded in a predetermined track of the recording layer of each sample in the manner of Working Example 1 except that the linear recording velocity was set to 10.6 m/sec.

Further, the random signal was recorded in the predetermined track of the recording layer of each sample using a different recording power of the laser beam. The bottom power of the laser beam was fixed at 0.5 mW.

Then, each of the optical recording medium sample #2 and the optical recording medium comparative sample #1 was set in the above mentioned optical recording medium evaluation apparatus and similarly to Working Example 1, a signal recorded in the predetermined track of the recording layer of each sample was reproduced, whereby clock jitter was measured.

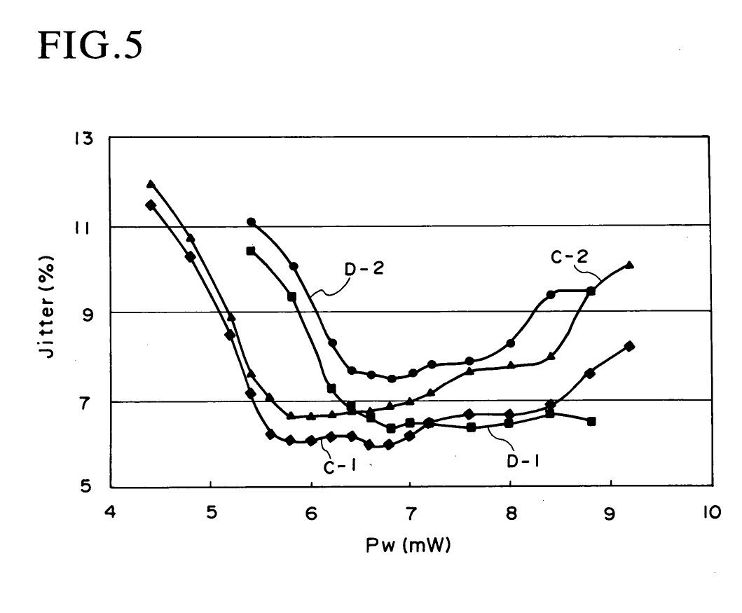

The results of the measurement are shown in FIG. 5.

In FIG. 5, the curve C-1 shows the results of the measurement of the optical recording medium sample #2 and the curve D-1 shows the results of the measurement of the optical recording medium comparative sample #1.

Then, each of the optical recording medium sample #2 and the optical recording medium comparative sample #1 was set in the above mentioned optical recording medium evaluation apparatus and random signals were recorded in tracks of the recording layer of each sample on the opposite sides of the predetermined track in the manner of Working Example 1 except that the linear recording velocity was set to 10.6 m/sec.

Further, the random signal was recorded in the track, of the recording layer of each sample on the opposite side of the predetermined track using a different recording power of the laser beam. The bottom power of the laser beam was fixed at 0.5 mW.

Then, each of the optical recording medium sample #2 and the optical recording medium comparative sample #1 was set in the above mentioned optical recording medium evaluation apparatus and similarly to Working Example 1, a signal recorded in the predetermined track of the recording layer of each sample was reproduced, whereby clock jitter was measured.

The results of the measurement are shown in FIG. 5.

In FIG. 5, th curve C-2 shows the results of the measurement of the optical recording medium sample #2 and the curve D-2 shows the results of the measurement of the optical recording medium comparative sample #1.

As shown in FIGS. 4 and 5, it was found in each case that the minimum value of clock jitter was lower in the optical recording medium sample #2 than that in the optical recording medium comparative sample #1 and that the range of the recording power of the laser beam by which data could be recorded without making clock jitter worse was wider in the optical recording medium sample #2 than that in the optical recording medium comparative sample #1.

It is reasonable to conclude that this was because the heat radiation layer of the optical recording medium sample #2 was formed of aluminum nitride having extremely high thermal conductivity and heat generated in the recording layer was quickly radiated, while the heat radiation layer of the optical recording medium comparative sample #1 was formed of Al₂O₃ having low thermal conductivity and heat generated in the recording layer was not quickly radiated.

The present invention has thus been shown and described with reference to specific embodiments. However, it should be noted that the present invention is in no way limited to the details of the described arrangements but changes and modifications may be made without departing from the scope of the appended claims.

For example, in the above described embodiment, the optical recording medium 10 includes the reflective layer 12, the second dielectric layer 13, the recording layer 14, the first dielectric layer 15, the heat radiation layer 16 and the light transmission layer 17 on the support substrate 11 in this order. However, in order to prevent the reflective layer 12 from being corroded, it is possible to form between the support substrate 11 and the reflective layer 12 a moisture-proof layer of oxide, sulfide, nitride or carbide of Al, Si, Ce, Ti, Zn, Ta or the like such as Al₂O₃, AlN, ZnO, ZnS, GeN, GeCrN, CeO₂, SiO, SiO₂, Si₃N₄, SiC, La₂O₃, TaO, TiO₂, SiAlON (mixture of SiO₂, Al₂O₃, Si₃N₄ and AlN), LaSiON (mixture of La₂O₃, SiO₂ and Si₃N) or the like. In the case where the moisture-proof layer is provided between the support substrate 11 and the reflective layer 12, it is preferable to form the moisture-proof layer of the mixture of ZnS and SiO₂.

Further, in the above described embodiment, although the optical recording medium 10 includes the reflective layer 12, the second dielectric layer 13, the recording layer 14, the first dielectric layer 15, the heat radiation layer 16 and the light transmission layer 17 on the support substrate 11 in this order, an interface layer may be formed between the recording layer 14 and the first dielectric layer 15 of the mixture of ZnS and SiO₂ whose mole ratio is 40:60 to 60:40. In the case where the interface layer is formed between the recording layer 14 and the first dielectric layer 15, it is preferable to form the interface layer using the mixture of ZnS and SiO₂ whose mole ratio is about 50:50 and to have a thickness thinner than that of the first dielectric layer 15. More specifically, in the case where the interface layer is formed of the mixture of ZnS and SiO₂ whose mole ratio is 50:50 and the first dielectric layer 15 is formed of the mixture of ZnS and SiO₂ whose mole ratio is 80:20, it is preferable to form the interface layer and the first dielectric layer 15 so that the interface layer has a thickness of 2 nm to 10 nm and that the first dielectric layer 15 has a thickness of 10 nm to 40 nm.

Furthermore, in the above described embodiment, although the optical recording medium 10 includes the reflective layer 12, the second dielectric layer 13, the recording layer 14, the first dielectric layer 15, the heat radiation layer 16 and the light transmission layer 17 on the support substrate 11 in this order, a hard coat layer may be formed on the surface of the light transmission layer 17 to protect the light transmission layer 17.

According to the present invention, it is possible to provide an optical recording medium whose durability is improved when data are reproduced repeatedly, which can suppress cross-erasing of data when data are recorded or erased, and in which data can be recorded with high sensitivity at a high velocity.

1. An optical recording medium comprising a recording layer in which a record mark can be formed by projecting a laser beam thereonto, a first dielectric layer disposed on the side of a light incidence plane through which the laser beam enters with respect to the recording layer, a second dielectric layer disposed on the opposite side to the light incidence plane with respect to the recording layer, a heat radiation layer disposed on the side of the light incidence plane with respect to the first dielectric layer and a reflective layer disposed on the opposite side to the light incidence plane with respect to the second dielectric layer, the recording layer containing a phase change material represented by a general formula: (SbₓTe₊ₓ)_{+y} M_{y} wherein M is an element other than Sb and Te, the first dielectric layer containing a mixture of ZnS and SiO₂, the reflective layer containing Ag or alloy containing 90 atomic % or more of Ag, and the heat radiation layer containing 90 atomic % or more of aluminum nitride.

2. An optical recording medium in accordance with claim 1, wherein a mole ratio of the mixture of ZnS and SiO₂ contained in the first dielectric layer is about 80:20.

3. An optical recording medium in accordance with claim 1, wherein the element M in the general formula is one or more elements selected from the group consisting of Ag, In, Ge and rare earth elements.

4. An optical recording medium in accordance with claim 2, wherein the element M in the general formula is one or more elements selected from the group consisting of Ag, In, Ge and rare earth elements.

5. An optical recording medium in accordance with claim 3, wherein the element M in the general formula is Ge and Tb or Ge and Mn.

6. An optical recording medium in accordance with claim 4, wherein the element M in the general formula is Ge and Tb or Ge and Mn.

7. An optical recording medium in accordance with claim 1, wherein the second dielectric layer contains a mixture of ZnS and SiO2 whose mole ratio is 40:60 to 60:40.

8. An optical recording medium in accordance with claim 2, wherein the second dielectric layer contains a mixture of ZnS and SiO2 whose mole ratio is 40:60 to 60:40.

9. An optical recording medium in accordance with claim 3, wherein the second dielectric layer contains a mixture of ZnS and SiO2 whose mole ratio is 40:60 to 60:40.

10. An optical recording medium in accordance with claim 4, wherein the second dielectric layer contains a mixture of ZnS and SiO2 whose mole ratio is 40:60 to 60:40.

11. An optical recording medium in accordance with claim 1, wherein a track pitch TP is determined so that TP/(λ/NA) is smaller than 0.7 where λ is a wavelength of the laser beam and NA is a numerical aperture of an objective lens.

12. An optical recording medium in accordance with claim 2, wherein a track pitch TP is determined so that TP/(λ/NA) is smaller than 0.7 where λ is a wavelength of the laser beam and NA is a numerical aperture of an objective lens.

13. An optical recording medium in accordance with claim 3, wherein a track pitch TP is determined so that TP/(λ/NA) is smaller than 0.7 where λ is a wavelength of the laser beam and NA is a numerical aperture of an objective lens.

14. An optical recording medium in accordance with claim 4, wherein a track pitch TP is determined so that TP/(λ/NA) is smaller than 0.7 where λ is a wavelength of the laser beam and NA is a numerical aperture of an objective lens.

15. An optical recording medium in accordance with claim 5, wherein a track pitch TP is determined so that TP/(λ/NA) is smaller than 0.7 where λ is a wavelength of the laser beam and NA is a numerical aperture of an objective lens.

16. An optical recording medium in accordance with claim 6, wherein a track pitch TP is determined so that TP/(λ/NA) is smaller than 0.7 where λ is a wavelength of the laser beam and NA is a numerical aperture of an objective lens.

17. An optical recording medium in accordance with claim 7, wherein a track pitch TP is determined so that TP/(λ/NA) is smaller than 0.7 where λ is a wavelength of the laser beam and NA is a numerical aperture of an objective lens.

18. An optical recording medium in accordance with claim 8, wherein a track pitch TP is determined so that TP/(λ/NA) is smaller than 0.7 where λ is a wavelength of the laser beam and NA is a numerical aperture of an objective lens.

19. An optical recording medium in accordance with claim 9, wherein a track pitch TP is determined so that TP/(λ/NA) is smaller than 0.7 where λ is a wavelength of the laser beam and NA is a numerical aperture of an objective lens.

20. An optical recording medium in accordance with claim 10, wherein a track pitch TP is determined so that TP/(λ/NA) is smaller than 0.7 where λ is a wavelength of the laser beam and NA is a numerical aperture of an objective lens.

21. An optical recording medium in accordance with claim 11, which further comprises a light transmission layer disposed on the side of the light incidence plane with respect to the heat radiation layer and is constituted so that data are recorded therein by employing an objective lens and a laser beam whose numerical aperture NA and wavelength λ satisfy λ/NA≦640 nm, and projecting the laser beam onto the recording layer via the light transmission layer.
